(19) United States
(12) Patent Application Publication
(10) Pub. No.: US 2002/0184348 A1
(43) Pub. Date: Dec. 5, 2002

(54) Object oriented framework architecture for sensing and/or control environments

(75) Inventors: John W. Rapp, Manassas, VA (US); Chandan Mathur, Burke, VA (US)

Correspondence Address: Bryan A. Santarelli, GRAYBEAL JACKSON HALEY LLP, 155 - 108th Avenue NE, Suite 350, Bellevue, WA, 98004-5901, US

(73) Assignee: Lockheed Martin Corporation

(21) Appl. No.: 10/052,744

(22) Filed: Jan. 18, 2002

Related U.S. Application Data
(63) Continuation-in-part of application No. 09/956,624, filed on Sep. 19, 2001.
(60) Provisional application No. 60/233,924, filed on Sep. 20, 2000.

(51) Int. Cl. G06F 15/173; G06F 15/177

(52) U.S. Cl. 709/220; 709/223

(57) ABSTRACT

An object oriented sensing/control framework architecture includes a sensor/controller framework module, an application services framework module, a signal database, and an application database. The sensor/controller framework module may exist within a sensor/controller gateway; the application services framework module may exist within an application services system. The sensor/controller framework module manages communication between 1) sensing/control subsystem elements, which generate and/or receive data and/or hardware signals; and 2) signal objects in the sensor/controller framework module and/or service objects in the application services framework module, which generate and/or receive event messages. Signal and/or service objects may be selectively associated with particular types of sensing and/or control subsystem elements, and process information within corresponding event messages. Associations between signal and/or service objects and sensing and/or control subsystem elements may be specified in the signal and/or the application database. Signal and/or service objects may be stored upon and distributed by an Object Database Management System.

### RELATED APPLICATIONS

This application is a Continuation-in-Part of U.S. patent application Ser. No. 09/956,624 entitled “Object Oriented Framework Architecture for Sensing and/or Control Environments,” filed on Sep.19, 2001.

### STATEMENT REGARDING GOVERNMENT AGENCY CONTRACT

The present invention was first conceived, reduced to practice, and/or built and tested in the course of work under U.S. Government Contract Number N00019-98-C-0012, “MKIII Weapons Systems Trainer.” The U.S. Government has certain rights in the invention.

### BACKGROUND OF THE INVENTION

1. Field of the Invention

The present invention relates generally to communication and computation processes within and/or between sensing and/or control systems. More particularly, the present invention is an object oriented framework architecture that may selectively instantiate intelligent objects to process information associated with particular sets of sensing and/or control subsystem elements.

2. Description of the Background Art

Sensing and/or control systems may be employed in a wide range of environments, such as simulation, manufacturing automation, industrial control, process monitoring, and/or remote sensing situations. Such systems typically incorporate specialized hardware elements in accordance with a set of requirements associated with a particular environment. The specificity of any given sensing and/or control system may preclude its applicability outside the environment for which it was designed. For example, a flight simulation system or elements therein may be of little or no use in an oil refinery process monitoring system.

Typically, a sensing and/or control system relies upon an application software design that is unique with respect to the system's particular hardware design. Once a hardware design for a given sensing and/or control system is finalized, application software design may proceed. Because software elements within a sensing and/or control system are intimately tied or bound to the system's hardware configuration or organization, the extent to which software elements can be leveraged or reused across different sensing and/or control systems is extremely limited. As a result of the foregoing, the time required to develop and implement a sensing and/or control system is undesirably long, and costs associated therewith are undesirably high.

The dependency of a system's application software design upon the system's hardware design generally precludes system modification or upgrade without time consuming and expensive application software modification, recompilation, and debugging. Present sensing and/or control systems therefore fail to flexibly, efficiently, or adequately accommodate technological evolution.

The dependency of application software upon sensing and/or control system hardware configuration also makes system scalability very difficult. Adding one or more local or remote subsystems to a given sensing and/or control system may necessitate extensive application software modification, recompilation, and debugging, which are typically time consuming, expensive procedures.

What is needed is a sensing and/or control architecture that minimizes the time required to design and implement a sensing and/or control system, and which maximizes system extensibility and scalability.

### SUMMARY OF THE INVENTION

In one embodiment, an object oriented framework architecture for sensing and/or control environments comprises an application services system, a signal database, an application database, a message database, at least one sensing/control framework and interface system having a set of sensing and/or control subsystems associated therewith, and an Object Database Management System (ODBMS) coupled to a network or network system.

Any given sensing and/or control subsystem may comprise one or more sensing and/or control subsystem elements capable of acquiring and/or distributing sensing and/or control signals within a particular environment. Various embodiments of the present invention may selectively employ intelligent objects to process information associated with particular sets and/or types of sensing and/or control subsystem elements. In the context of the present invention, an intelligent object may comprise a software object having program instructions for processing events and/or other information corresponding to the sensing and/or control subsystem elements with which the intelligent object is associated.

The ODBMS may serve as a repository and distribution manager for intelligent objects, which include signal objects and service objects. The ODBMS may comprise an object server, an object index, a signal object library for storing signal objects, and a service object library for storing service objects. Signal objects may comprise intelligent objects associated with a sensing/control framework and interface system, while service objects may comprise intelligent objects associated with an application services system.

A sensing/control framework and interface system may comprise a sensor/controller gateway that is coupled to a set of electrical interface units and the network. An electrical interface unit may be coupled to a sensing and/or control subsystem, and may comprise one or more expansion buses and a set of signal exchange modules. Signal exchange modules may comprise hardware and/or software for communicating with sensing and/or control subsystem elements. Such communication occurs in the form of hardware signals and/or data signals, the nature of which may be dependent upon the particular type of sensing and/or control element(s) to which a signal exchange module corresponds and/or the specific manner in which the signal exchange module is implemented.

The sensor/controller gateway may comprise a computer in which an object manager, and object cache, and a sensor/controller framework module reside. The object manager may oversee the exchange of signal objects and/or references thereto between the ODBMS and the object cache. The sensing/control framework module may manage information transfer or exchange between signal exchange modules, signal objects, and/or service objects. In one embodiment, a sensing/control framework module comprises an object oriented software framework that includes a configuration and initialization module; a memory mapping module; an event coding/decoding module; an inter-process communication (IPC) module; a scheduling module; one or more hardware interface modules; and possibly a set of signal objects.

The configuration and initialization module may retrieve configuration information from the signal database, the contents of which may define and/or describe signal exchange modules, manners of communicating therewith, associations between signal exchange modules and signal objects, and other information. Based upon retrieved configuration information, the configuration and installation module may generate and/or retrieve one or more portions of a hardware interface module. The hardware interface module serves as a communication interface between a signal exchange module and the sensor/controller framework module.

The configuration and initialization module may additionally or alternatively retrieve or request one or more signal objects from the ODBMS in accordance with retrieved configuration information. For each signal object, the configuration and initialization module may retrieve a set of event message identifiers from the message database, where such message identifiers may indicate to which event messages the signal object responds during system operation.

The event coding/decoding module may map, encode, and/or encapsulate data signals into event messages, each of which may comprise an event identifier and associated data values. The encoding, mapping, and/or encapsulation of data signals into event messages disassociates data signal content from format variations arising form signal exchange module and/or sensing and/or control subsystem element implementation details. Finally, the IPC module may orchestrate the transfer or exchange of event messages between signal and/or service objects.

A signal object may selectively process event messages associated with one or more signal exchange modules. The signal object may further communicate with one or more service objects and/or external entities or systems. The processing performed by signal objects may involve preprocessing, postprocessing, parameter extraction, content filtering, occurrence counting, data compression and/or decompression, and/or other operations.

In one embodiment, an application services system comprises a computer system in which an object manager, an object cache, and an application services framework module reside. The object manager may oversee the exchange of service objects between the ODBMS and the object cache. The application services framework module may selectively perform application level processing operations in response to and/or during the generation of event messages associated with sensing and/or control subsystem elements.

In one embodiment, the application services framework module comprises an object oriented software framework that includes a configuration and initialization module, and IPC module, and a set of service objects. The configuration and initialization module may retrieve configuration information from the application database, where such information may include an application identifier, a set of service object identifiers corresponding to the application identifier, and possibly other information. The configuration and initialization module may issue requests to the object manager to retrieve service objects and/or references thereto from the ODBMS. For each service object retrieved, the configuration and initialization module may retrieve a set of event message identifiers from the message database, where such message identifiers may indicate to which event messages the service object responds during system operation. The IPC module may manage the exchange of event messages between various network connections and service objects.

Any given service object may process information contained within event messages that correspond to one or more types of sensing and/or control subsystem elements. A service object may further communicate with entities external to the architecture 105 as part of processing such information. Such communication may involve, for example, the generation and transmission of Extensible Markup Language (XML) pages, and/or other types of documents.

### BRIEF DESCRIPTION OF THE DRAWINGS

FIG. 1 is a block diagram of an object oriented framework architecture for sensing and/or control environments organized in accordance with an embodiment of the invention.

FIG. 2 is a block diagram of a framework and interface system according to an embodiment of the invention.

FIG. 3 is a functional block diagram of a framework services module 330 and a manner of interfacing to signal exchange module hardware according to an embodiment of the invention.

FIG. 4 is a set of signal database objects or tables specifying exemplary configuration information for a signal exchange module implemented as an IP module.

FIG. 5 is a block diagram of an object oriented framework architecture for sensing and/or control environments organized in accordance with another embodiment of the invention.

FIG. 6 is a block diagram of a framework and interface system according to another embodiment of the invention.

FIG. 7A is a functional block diagram of a sensing/control framework module and a manner of interfacing to signal exchange module hardware according to an embodiment of the invention.

FIG. 7B is a functional block diagram of a sensing/control framework module and a manner of interfacing to signal exchange module hardware according to another embodiment of the invention.

FIG. 8 is a set of signal database objects or tables that specify exemplary configuration information for a signal exchange module.

FIG. 9 is a message database object or table organized in accordance with an embodiment of the invention.

FIG. 10 is a functional block diagram of an application services framework module according to an embodiment of the invention.

FIG. 11 is an application database object or table that specifies exemplary configuration information for a set of application services.

FIG. 12 is a block diagram showing an exemplary airport security environment served by an embodiment of the present invention.

### DETAILED DESCRIPTION

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

The present invention comprises an object oriented framework architecture for sensing and/or control systems. The architecture embodiments detailed herein facilitate efficient and cost effective design and implementation of sensing and/or control systems that are extensible and scalable. Those skilled in the art will recognize that various embodiments of the present invention may be applicable to essentially any type of local and/or remote sensing and/or control environment. Embodiments of the present invention may also be applicable to compute service and/or file service environments.

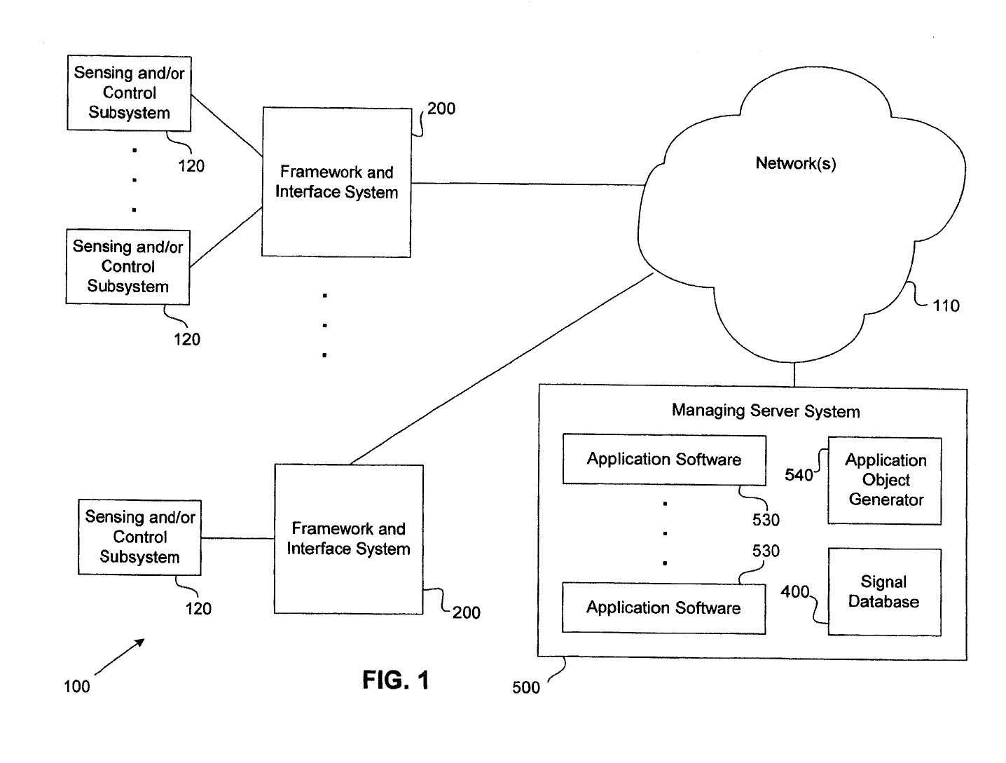

FIG. 1 is a block diagram of an object oriented sensing and/or control framework architecture 100 according to an embodiment of the invention. In one embodiment, the object oriented sensing and/or control framework architecture 100 comprises a managing server system 500 in which an application software program 530 (also referred to herein simply as application software) and other software elements 540 may reside; at least one signal database 400 associated with the managing server system 500; at least one framework and interface system 200 having a set of sensing and/or control subsystems 120 associated therewith; and a network or network system 110.

The managing server system 500 may be coupled to one or more framework and interface systems 200 via the network 110, which may comprise one or more networks of essentially any type, including the Internet, a Local Area Network (LAN), a Wide Area Network (WAN), a satellite communication network, and/or a wire-based and/or wireless telephone network. Some portions of the network 110 may be public, while other portions may be private. Those skilled in the art will understand that the network 110 may comprise various types of network elements organized to support and/or communicate in accordance with one or more network and/or information transport protocols. In an alternate embodiment, the managing server system 500 may be directly coupled to one or more framework and interface systems 200 in a manner that omits or bypasses the network 110.

In one embodiment, any given framework and interface system 200 is coupled to at least one corresponding sensing and/or control subsystem 120. A sensing and/or control subsystem 120 may comprise various types of sensing and/or control elements directed toward signal acquisition and/or distribution within a particular environment. Such signals may be analog, digital, serial, or of other types, in accordance with the communication formats and/or protocols supported by the sensing and/or control elements to which they correspond. Sensing and/or control subsystem elements may include wire-based, wireless, electro-optic, fiber optic, and/or optical components, in a manner readily understood by those skilled in the art. Sensing elements may include, for example, switches, temperature sensors, pressure sensors, vibration sensors, position or attitude sensors, motion sensors, accelerometers, microphones or hydrophones, and feedback from various types of actuators. Control elements may include lights (e.g., lamps and/or LED's), digital or analog meters, thermostats, hydraulic controls, motor controls, engine controls, transducers, loudspeakers, alarm indicators, stepping motors, and various types of actuators. Examples of signal types that may cross boundaries between the framework and interface system 200 and a sensing and/or control subsystem 120 are shown in Table 1.

TABLE 1
Exemplary Signal Types Supported

| Sensed Signal Type | Controlled Signal Type |
|---|---|
| Synchro (Rotating Power) | Synchro (Rotating Power) |
| Low Voltage Analog | Low Voltage Analog |
| High Voltage Analog | High Voltage Analog |
| Low Current Analog | Low Current Analog |
| High Current Analog | High Current Analog |
| Optically Isolated Interrupt | Optically Isolated Interrupt |
| Low Voltage Discrete Digital | Low Voltage Discrete Digital |
| 5 Volt (TTL Level) Discrete | 5 Volt (TTL Level) Discrete |
| Digital | Digital |
| High Voltage Discrete Digital | High Voltage Discrete Digital |
| IEEE 422, 232 | IEEE 422, 232 |
| ARINC 429, 568, 582 | ARINC 429, 568, 582 |
| MIL 1553B, 1553A | MIL 1553B, 1553A |
| | Relay (Switched Signal or Power) |

In one embodiment, any given sensing and/or control subsystem 120 and/or particular sensing and/or control elements therein may be monitored, managed, and/or controlled by one or more application software programs 530 executing within the managing server system 500. Communication between sensing and/or control subsystems 120 and the managing server system 500 occurs through a framework and interface system 200, as described in detail below.

The managing server system 500 itself may comprise a computer having one or more of the following as required: a processing unit, a set of input devices, a display device, a data storage unit, a network interface unit, and a memory, in a manner readily understood by those skilled in the art. Within the managing server's memory, an operating system may manage access to various hardware and/or software resources in a manner readily understood by those skilled in the art. Those skilled in the art will further understand that the operating system may be a real-time or non-real-time operating system, in accordance with temporal demands associated with any given sensing and/or control environment.

Application software 530 may comprise program instructions that reside within the managing server's memory and/or upon a data storage unit. Typically, a particular application software program 530 is associated with a specific sensing and/or control environment. The network-based access to the managing server system 500 may facilitate monitoring and/or management of multiple sensing and/or control environments by one or multiple application programs 530.

In prior sensing and/or control architectures, communication processes between sensing and/or control elements and monitoring and/or control software are inflexibly bound in accordance with a particular hardware configuration. In stark contrast, the present invention provides a self-configuring hardware abstraction layer that generalizes and manages hardware-software communication processes to greatly reduce the extent to which application software 530 is dependent upon hardware configuration details. In one embodiment, a framework and interface system 200, in conjunction with a signal database 400, serves as a configuration and communication interface between one or more sensing and/or control subsystems 120 and application software 530 to provide the aforementioned abstraction layer as described in detail hereafter.

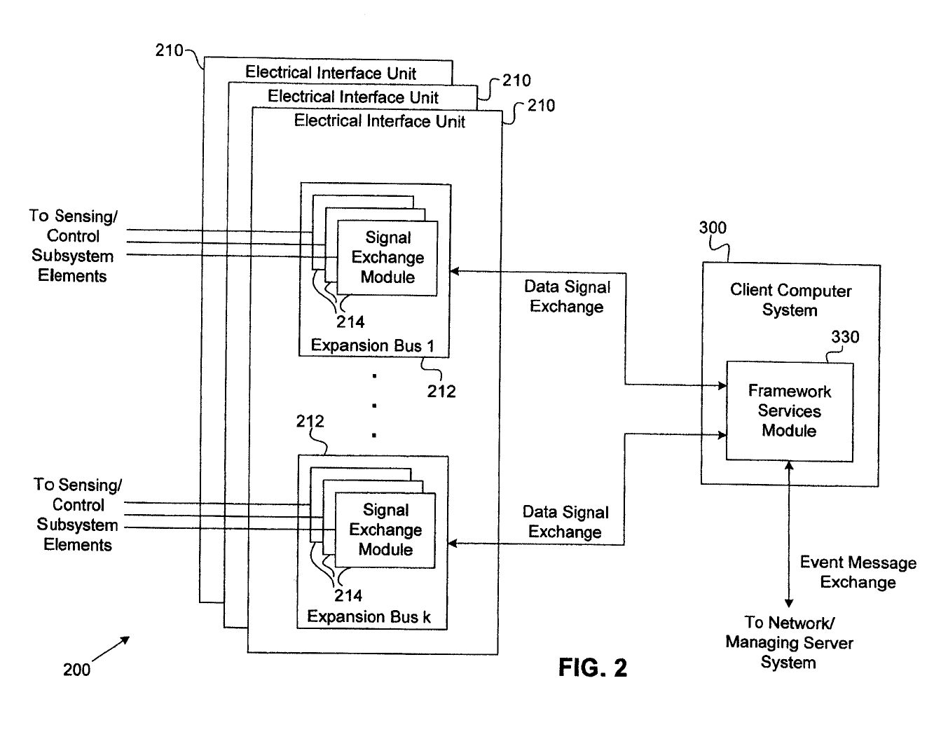

FIG. 2 is a block diagram of a framework and interface system 200 according to an embodiment of the invention. The framework and interface system 200 may comprise a set of electrical interface units 210, and a sensor/controller gateway or client computer system 300 having a framework services module 330 therein. Each electrical interface unit 210 may be coupled to a sensing and/or control subsystem 120 as well as the sensor/controller gateway 300, which may further be coupled to the managing server system 500.

The sensor/controller gateway 300 may comprise a computer having a processing unit, a set of input devices, a display device, a data storage unit, a network interface unit, and a memory, in a manner readily understood by those skilled in the art. An operating system residing within the memory may manage access to various hardware and/or software resources within the sensor/controller gateway 300, in a manner readily understood by those skilled in the art. Those skilled in the art will additionally recognize that the operating system may be a real-time or non-real-time operating system in accordance with temporal processing requirements associated with any given sensing and/or control subsystem 120. The framework services module 330 may comprise program instructions that reside within memory and/or upon the data storage unit, and which provide functionality described in detail below.

In one embodiment, an electrical interface unit 210 comprises one or more expansion buses 212 and a set of signal exchange modules 214 coupled thereto. Signal exchange modules 214 may reside upon expansion bus or mezzanine bus cards, which plug into an expansion bus 212 in a conventional manner. Any given expansion bus card upon which a signal exchange module 214 resides may itself reside upon a carrier board. A carrier board may reside within a rack, which may reside within an enclosure, in a manner readily understood by those skilled in the art. Alternatively or additionally, one or more portions of a given electrical interface unit 210 may reside within the sensor/controller gateway 300.

Any given signal exchange module 214 may correspond to a set of sensing and/or control subsystem elements, and may comprise circuitry for exchanging analog and/or digital signals therewith. A signal exchange module 214 may include analog-to-digital (A/D) and/or digital-to-analog (D/A) conversion circuitry, signal conditioning and/or processing circuitry, interrupt management circuitry, and/or one or more registers or data storage elements, in a manner readily understood by those skilled in the art. A signal exchange module 214 may further include a Programmable Read Only Memory (PROM) that stores information identifying and/or describing the signal exchange module 214 and its supported modes of operation. A signal exchange module 214 may be implemented, for example, using an Industry Pack (IP) module, in a manner readily understood by those skilled in the art.

An expansion bus 212 provides a set of datapaths that facilitate communication between one or more signal exchange modules 214 and the sensor/controller gateway 300. An expansion bus 212 may comprise essentially any type of bus implemented in accordance with known bus architecture definitions, such as a VersaModular Eurocard (VME) bus or a Peripheral Components Interconnect (PCI) bus.

A signal exchange module 214 may receive an electrical signal from a sensing and/or control subsystem element, perform any required signal conditioning, format conversion, and/or local processing thereupon, and store one or more corresponding hardware signals or data signals in a register, storage element, or memory. An expansion bus 212 to which the signal exchange module 214 is coupled may facilitate transfer of such data signals to or retrieval of such data signals by the sensor/controller gateway 300. Similarly, the sensor/controller gateway 300 may transfer one or more data signals to a signal exchange module 214, which may perform any required signal conversion operations thereupon and/or deliver a corresponding electrical signal to a sensing and/or control subsystem element.

Within the sensor/controller gateway 300, the framework services module 330 manages information exchange between application software 530 and signal exchange modules 214. Communication between the framework services module 330 and signal exchange modules 214 comprises the exchange of hardware signals or data signals. Any given data signal may directly correspond to a particular signal exchange module 214. Moreover, the manner in which any given data signal is exchanged may depend upon the manner in which its associated signal exchange module 214 is implemented.

In contrast, communication between the framework services module 330 and application software 530 comprises the exchange of events or event messages. In the context of the present invention, an event may correspond to a condition or occurrence having meaning or relevance to application software 530 for the purpose of monitoring or managing a sensing and/or control subsystem 120. In one embodiment, an event or event message comprises an event identifier and a set of data values associated therewith. As described in detail below, the present invention associates event identifiers with data signals in a flexible manner. The use of event identifiers advantageously disassociates application software 530 from signal exchange module configuration and communication details.

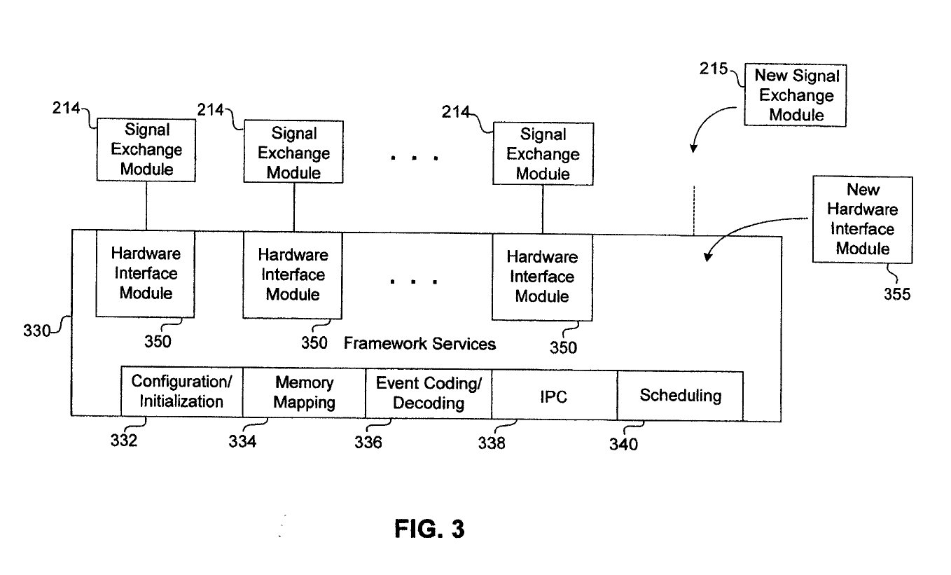

FIG. 3 is a functional block diagram of a framework services module 330 and a manner of interfacing to signal exchange module hardware according to an embodiment of the invention. In one embodiment, the framework services module 330 comprises an object oriented software framework having a configuration and initialization module 332; a memory mapping module 334; an event coding/decoding module 336; an inter-process communication (IPC) module 338; and a scheduling module 338, each of which provides a core type of framework services module functionality as further described below. The framework services module 330 may additionally comprise one or more hardware interface modules 350 that communicate with corresponding signal exchange modules 214. As described in detail below, the configuration and initialization module 332 may automatically generate a hardware interface module 350 in a manner that flexibly accommodates or accounts for hardware dependencies, thereby providing the framework services module 330 with extensible functionality.

The configuration and initialization module 332 may operate during an initialization mode to retrieve from the signal database 400 configuration information describing one or more signal exchange modules 214 within an electrical interface unit 210 to which the framework services module 300 is coupled. The configuration and initialization module 332 may build, generate, or retrieve one or more portions of a hardware interface module 350 for communicating with a signal exchange module 214 using the retrieved configuration information.

In particular, upon retrieving such information associated with a given signal exchange module 214, the configuration and initialization module 332 may initiate or invoke a set of executable files for generating one or more portions of a hardware interface module 350, passing as parameters to such executable files particular configuration information retrieved from the signal database 400. Such parameters may comprise a) one or more location identifiers that uniquely specify where the signal exchange module 214 physically and/or logically resides; b) a communication interface definition for the signal exchange module 214, which may include a port number, one or more interrupt definitions, and/or storage element identifications and/or descriptions; c) data signal definitions for each data signal that the signal exchange module 214 may exchange; d) an event identifier, such as a number and/or character, associated with each such data signal; and/or e) other information, such as a manufacturer name and model number.

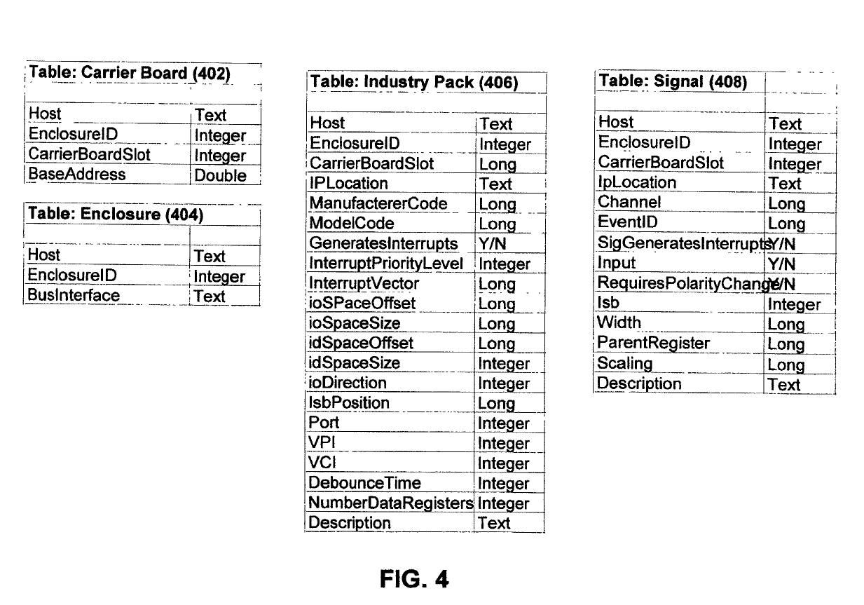

FIG. 4 is a set of signal database objects or tables 402, 404, 406, 408 for specifying exemplary configuration information for a signal exchange module 214 implemented as an IP module. In general, the signal database 400 comprises objects or structures that define a hardware/software boundary. Such objects or structures may include parameters or attributes describing or elaborating upon characteristics of each signal exchange module 214. Such parameters may specify how the signal exchange module 214 may be accessed to exchange particular data signals corresponding thereto, and mappings between such data signals and event identifiers. Particular parameter values within any given signal database object or table 402, 404, 406, 408 may be determined automatically, for example, by retrieval of information specified in one or more hardware description files. In one embodiment, the signal database 400 may reside within a data storage unit associated with the managing server system 500. One or more portions of the signal database 400 may reside elsewhere in an alternate embodiment, such as upon the sensor/controller gateway 300 or within a Network Attached Storage (NAS) device, in a manner readily understood by those skilled in the art.

Referring again to FIGS. 1-3, the memory mapping module 334 may map a register and/or a memory address space associated with each signal exchange module 214 to addresses within the sensor/controller gateway's memory, such that signal exchange module storage locations appear as local addresses to the framework services module 330. The event coding/decoding module 336 may encode data signals received from signal exchange modules 214 into corresponding events directed to application software 530 during system operation. The event coding/decoding module 336 may further transform events received from application software 530 into data signals directed to appropriate signal exchange modules 214, after which one or more hardware interface modules 350 may deliver such data signals thereto to effectuate subsystem control. In one embodiment, an event comprises an event identifier and one or more data values representing the data signal that corresponds to the event identifier.

The IPC module 338 may manage communication between the framework services module 330 and application software 530. In one embodiment, the IPC module 338 transmits events to and receives events from application software 530 during system operation. The scheduling module 340 may oversee or perform periodic or a periodic data collection operations within the framework services module 300 to facilitate communication with application software 530.

Each data signal output by any given signal exchange module 214 may be associated with an event identifier within the signal database 400. Application software 530 is responsive to the receipt of an event rather than direct receipt of a data signal. Upon receipt of an event, the application software 530 may respond by taking an action corresponding to the event, and/or generating another event and returning it to the framework services module 300. The underlying hardware in any given electrical interface unit 210 is thus transparent to the application software 530. In other words, an application program 530 does not require knowledge of which or which type of signal exchange module 214 led to the generation of an event, but need only take appropriate action in response to receipt of such an event. For example, if an operator in a cockpit simulation system moves a switch into an ON position, this may be encoded as event number five. Relative to application software 530, identification of which signal exchange module 214 detected the movement of the switch into the ON position may be unimportant or unnecessary.

The architecture 100 thus eliminates the dependency between application software 530 and signal exchange module hardware configuration. The application software 530 need not be modified each time the configuration of signal exchange modules 214 changes, thereby eliminating time consuming application software recompilation, testing, and debugging procedures. For example, a new signal exchange module 215 may be plugged into an electrical interface unit 210 and the signal database 400 may be updated to describe the new signal exchange module 215 in a manner analogous to that detailed above in FIG. 4. In particular, signal database objects 402, 404, 406, 408 corresponding to the new signal exchange module 215 may be created or instantiated as part of a signal database update procedure. The configuration and initialization module 332 may subsequently execute an initialization or update routine, retrieving information from the signal database 400 and generating a new hardware interface module 355 for communicating with the new signal exchange module 215. The architecture 100 further provides for hardware debugging and error correction without application software modification in an analogous manner.

The architecture 100 described above may significantly reduce the labor required to provide sensing and/or control system documentation and a translation of a hardware layout into a software design. The signal database 400 includes the needed interface documentation for defining hardware/software boundaries. As engineers analyze external hardware circuitry, the hardware design may be captured in the signal database 400. Software boundary documentation may be provided by a printout of signal database contents.

Typically, software engineers rely upon software boundary documentation to generate code specific to a hardware design. In contrast, the managing server system 500 may include an application object generator 540 that automatically generates objects or code for processing events based upon and/or in accordance with a hardware design captured in the signal database 400. The present invention thereby may significantly reduce the time and cost associated with application software development. Those skilled in the art will understand that an application object generator 540 need not reside and/or execute upon or within the managing server system 500, but may reside and/or execute upon another computer system having access to the signal database 400.

The architecture 100 described above may be applied to essentially any type of local or distributed sensing and/or control environment. Additionally, the architecture 100 may be readily scaled. The architecture 100 may include multiple framework and interface systems 200, where signal exchange modules 212 associated therewith are described in a signal database 400. Additionally, because the architecture 100 may be network-based and/or internet-based, the architecture 100 may readily facilitate communication between application software 530 and sensing and/or control subsystems 120 located in various parts of the world.

Examples of sensing and/or control environments to which the architecture 100 described above may be applied include the following: a facility-wide oil refinery control system; a facility-wide electrical power plant control system; a distributed flight simulation training suite having a cockpit simulator in one location for pilots, and a cabin simulator in another location for crew members; an integrated naval ship simulation system, including propulsion, navigation, radar, acoustics, and/or fire control subsystems; an integrated merchant ship simulation system, including propulsion, navigation, radar, and/or cargo hold control and sensing subsystems; and a coastal defense system that includes multiple underwater hydrophone subsystems.

### OTHER EMBODIMENTS

In addition to the advantages described above, other embodiments of the present invention may facilitate further reductions in application development and/or deployment times, and/or enhanced system extensibility. In particular, various embodiments of the present invention may selectively instantiate intelligent software objects that process information and/or generate output associated with sensing and/or control subsystem elements, as described in detail hereafter. Relative to the architecture 100 previously described, like reference numbers below may indicate identical, essentially identical, or analogous elements.

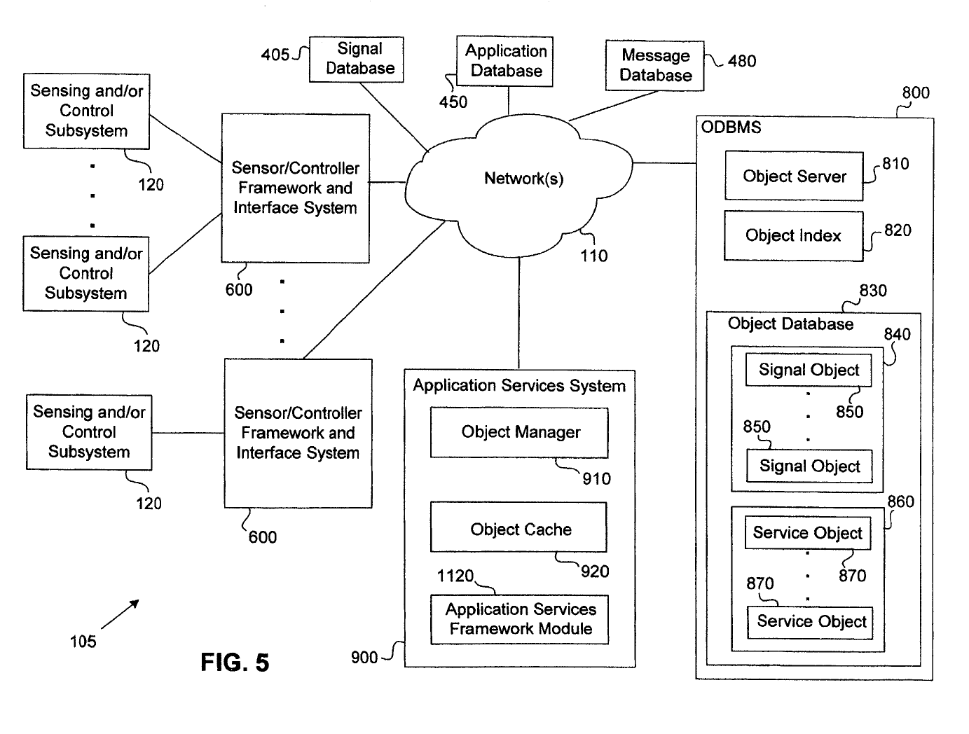

FIG. 5 is a block diagram of an object oriented sensing and/or control framework architecture 105 according to another embodiment of the invention. In one embodiment, the object oriented sensing and/or control framework architecture 105 comprises an application services system 900; a signal database 405; an application database 450; a message database 480; at least one sensing/control framework and interface system 600 having a set of sensing and/or control subsystems 120 associated therewith; an Object Database Management System (ODBMS) 800; and a network or network system 110.

The application services system 900 may be coupled to one or more sensing/control framework and interface systems 600, the signal database 405, the application database 450, the message database 480, and/or the ODBMS 800 via the network 110. The network 110 may comprise one or more networks and associated network support elements in a manner identical or analogous to that described above. Any given sensing/control framework and interface system 600 may be coupled to one or more corresponding sensing and/or control subsystems 120. A sensing and/or control subsystem 120 may comprise various types of sensing and/or control elements directed toward signal acquisition and/or distribution within a particular environment, where such sensing and/or control elements as well as the signals associated therewith may be of essentially any type, including those described above.

The ODBMS 800 comprises an object oriented database management system that stores, maintains, and/or distributes intelligent objects. In the context of the present invention, an intelligent object comprises a software object that includes program instructions for processing event messages and/or related information corresponding to one or more types of sensing and/or control subsystem elements. In one embodiment, intelligent objects may autonomously or semi-autonomously communicate with hardware, software, and/or systems external to the architecture 105, as further described below.

The ODBMS 800 may comprise an object server 810, an object index 820, and an object database 830, in a manner understood by those skilled in the art. The OBDMS 800 may be conventional, and may be implemented using a high-availability computing system. The object index 820 may include an object identification corresponding to each intelligent object stored or referenced within the ODBMS 800. In one embodiment, the object database 830 includes a signal object library 840 for storing signal objects 850, and a service object library 860 for storing service objects 870. Signal objects 850 may comprise intelligent objects that are selectively instantiated within or in association with a sensing/control framework and interface system 600. Signal objects 850 may manage communication with and/or process event messages corresponding to sensing and/or control subsystem elements. Service objects 870 may comprise intelligent objects that are selectively instantiated within or in association with an application services system 900, and which may perform or provide application-level processing services corresponding to various types of sensing and/or control subsystem elements.

Signal objects 850 and/or service objects 870 may be defined in accordance with a hierarchical organization, in a manner readily understood by those skilled in the art. Additionally, signal objects 850 and/or service objects 870 may publish or subscribe from a common object or a common object set. The program instructions comprising signal and/or service objects 850, 870 define possible client-side and/or server side object behaviors. Additionally, signal and/or service objects 850, 870 may themselves comprise and/or reference objects that functionally cooperate in the context of one or more client-server strings.

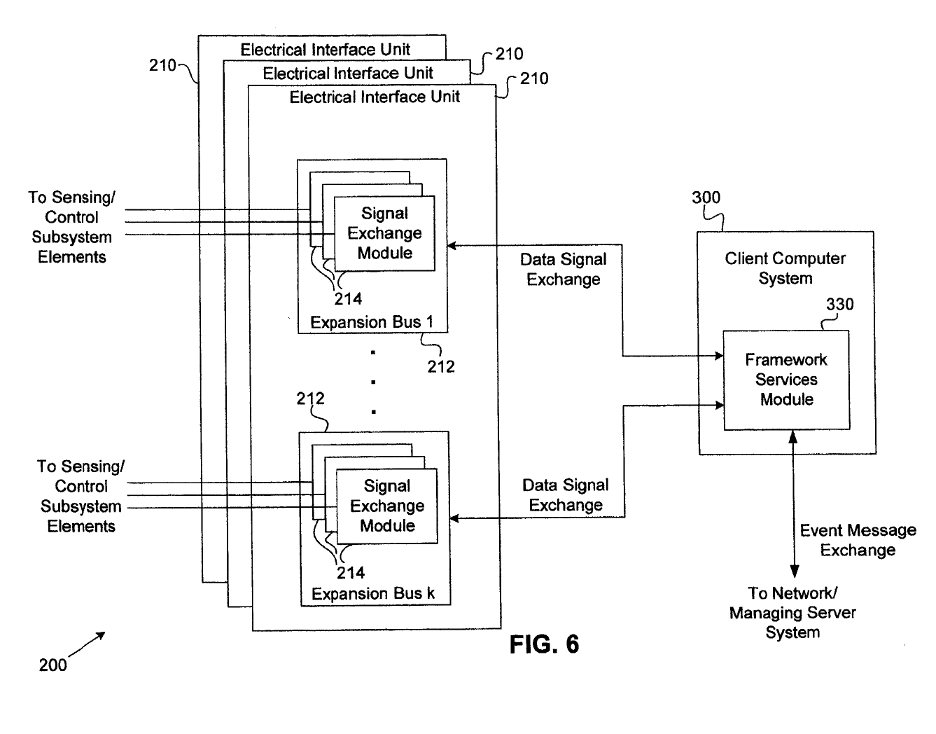

FIG. 6 is a block diagram of a sensor/controller framework and interface system 600 according to an embodiment of the invention. The sensor/controller framework and interface system 600 may comprise a sensor/controller gateway 700 coupled to a set of electrical interface units 210. An electrical interface unit 210 may be coupled to one or more sensing and/or control subsystems 120, and may be structurally and/or functionally identical or analogous to an electrical interface unit 210 described above.

Thus, an electrical interface unit 210 may comprise one or more expansion buses 212 coupled to a set of signal exchange modules 214. Any given signal exchange module 214 may comprise circuitry for exchanging analog and/or digital signals with sensing and/or control subsystem elements. A signal exchange module 214 may receive an electrical signal from a sensing and/or control subsystem element, perform any required signal conditioning, format conversion, and/or local processing thereupon, and store one or more corresponding hardware signals or data signals in a register, storage element, or memory. An expansion bus 212 to which the signal exchange module 214 is coupled may facilitate transfer of such data signals to or retrieval of such data signals by the sensor/controller gateway 700. Similarly, the sensor/controller gateway 700 may transfer one or more data signals to a signal exchange module 214, which may perform any required signal conversion operations thereupon and/or deliver a corresponding electrical signal to a sensing and/or control subsystem element.

The sensor/controller gateway 700 may comprise a computer having a processing unit, a set of input devices, a display device, a data storage unit, a network interface unit, and a memory, in a manner readily understood by those skilled in the art. An operating system, an object manager 710, an object cache 720, and a sensing/control framework module 730 may reside within the sensor/controller gateway's memory. The operating system may manage access to various hardware and/or software resources within the sensor/controller gateway 700, in a manner readily understood by those skilled in the art. Those skilled in the art will additionally recognize that the operating system may be a real-time or non-real-time operating system in accordance with temporal processing requirements associated with any given sensing and/or control subsystem 120.

The object manager 710 may direct the exchange of signal objects 550 and/or references thereto between the ODBMS 800 and the sensor/controller gateway 700, as requested by the sensing/control framework module 730 or as otherwise necessary. Within the sensor/controller gateway 700, signal objects 850 and/or references thereto may reside within the object cache 720. Those skilled in the art will understand that one or more portions of the object manager 710 and the object cache 720 may be conventional.

The sensing/control framework module 730 may manage information transfer or exchange between signal exchange modules 214, signal objects 850, and/or service objects 870. The sensing/control framework module 730 may comprise program instructions that reside within the sensor/controller gateway's memory and/or upon its data storage unit. In one embodiment, the sensing/control framework module 730 is structurally and/or functionally identical or essentially identical to the framework services module 330 described above. In other embodiments, the sensing/control framework module 730 includes, incorporates, or operates in conjunction with signal objects 850, as described in detail hereafter.

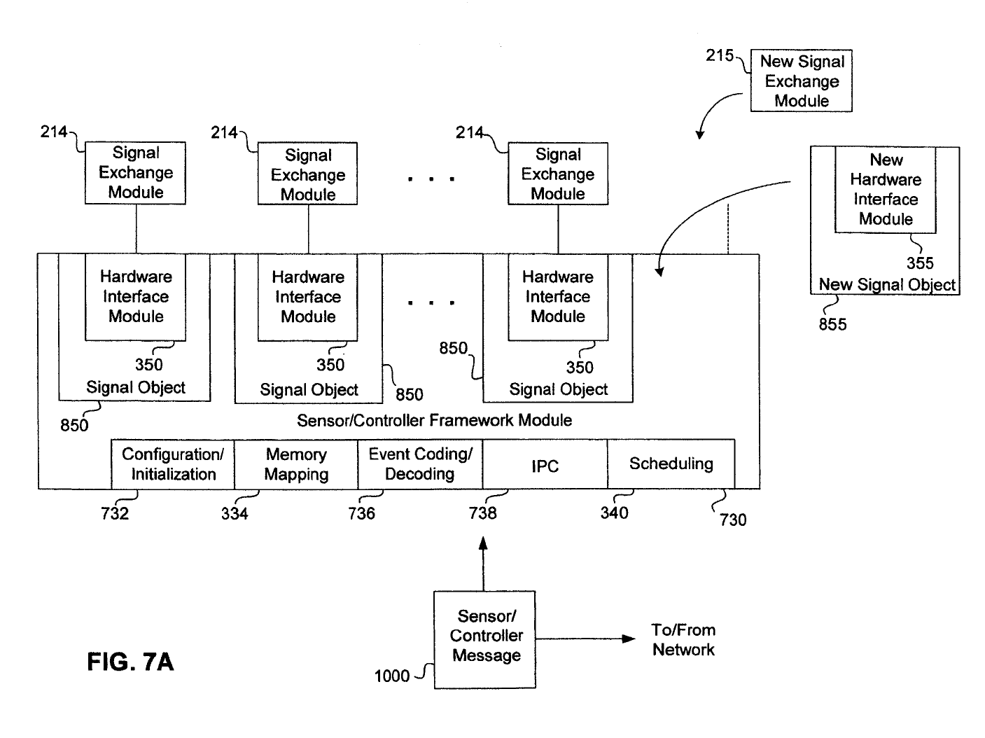

FIG. 7A is a functional block diagram of a sensing/control framework module 730 and a manner of interfacing to signal exchange module hardware according to an embodiment of the invention. In one embodiment, the sensing/control framework module 730 comprises an object oriented software framework having a configuration and initialization module 732; a memory mapping module 334; an event coding/decoding module 736; an inter-process communication (IPC) module 738; and a scheduling module 340, each of which provides a core type of framework functionality in a manner identical or analogous to that described above, and/or as further described below.

The sensing/control framework module 730 may additionally comprise a set of hardware interface modules 350, as well as one or more signal objects 850 associated therewith. Each hardware interface module 350 comprises a communication interface to a corresponding signal exchange module 214. A signal object 850 may selectively process information associated with one or more hardware interface modules 350, and possibly communicate with one or more service objects 870 and/or entities or systems external to the architecture 105. Signal objects 850 may process information received from or directed to the hardware interface modules 350 with which they are associated. Such processing may involve preprocessing, postprocessing, parameter extraction, content filtering, occurrence counting, and/or other operations. A signal object 850 may include or implement, for example, a data compression engine.

In the embodiment shown in FIG. 7A, hardware interface modules 350 are subsumed within signal objects 850. In other embodiments, hardware interface modules 350 and signal objects 850 may be implemented separately. FIG. 7B is a functional block diagram of a sensing/control framework module 750 according to another embodiment of the invention. In the embodiment shown in FIG. 7B, hardware interface modules 350 may be implemented in a manner identical or analogous to that described above with reference to the framework services module 330. In such an embodiment, any given signal object 850 may be associated with one or more hardware interface modules 350 (or signal exchange modules 214), as described in detail below.

A sensing/control framework module 730, 750 may manage information flow between signal exchange modules 214, signal objects 850, and/or service objects 870. Communication between the sensing/control framework module 730, 750 and signal exchange modules 214 comprises the exchange of hardware signals or data signals. Any given data signal may directly correspond to a particular signal exchange module 214. The manner in which any given data signal is exchanged may depend upon the manner in which its associated signal exchange module 214 is implemented.

In contrast, communication involving signal objects 850 and/or service objects 870 may comprise the exchange of events or event messages, where an event or event message comprises an event identifier and a set of data values associated therewith. In FIG. 7B, an event message is indicated as a sensor/controller message 1000. Signal objects 850 within or associated with the sensing/control framework module 750 may selectively respond to particular sensor/controller messages 1000, thereby processing information associated with particular signal exchange modules 214. Manners in which elements within a sensing/control framework module 730, 750 may configure and/or control the module 730, 750 to effectuate appropriate types of communication between signal exchange modules 214, signal objects 850, and/or service objects 870 are described in detail hereafter.

The configuration and initialization module 732 may operate during an initialization mode to retrieve configuration information from the signal database 405. In one embodiment, configuration information describes a) one or more signal exchange modules 214 within an electrical interface unit 210 to which the sensing/control framework module 730, 750 is coupled; and possibly b) one or more manners in which a set of signal objects 850 may be associated with such signal exchange modules 214.

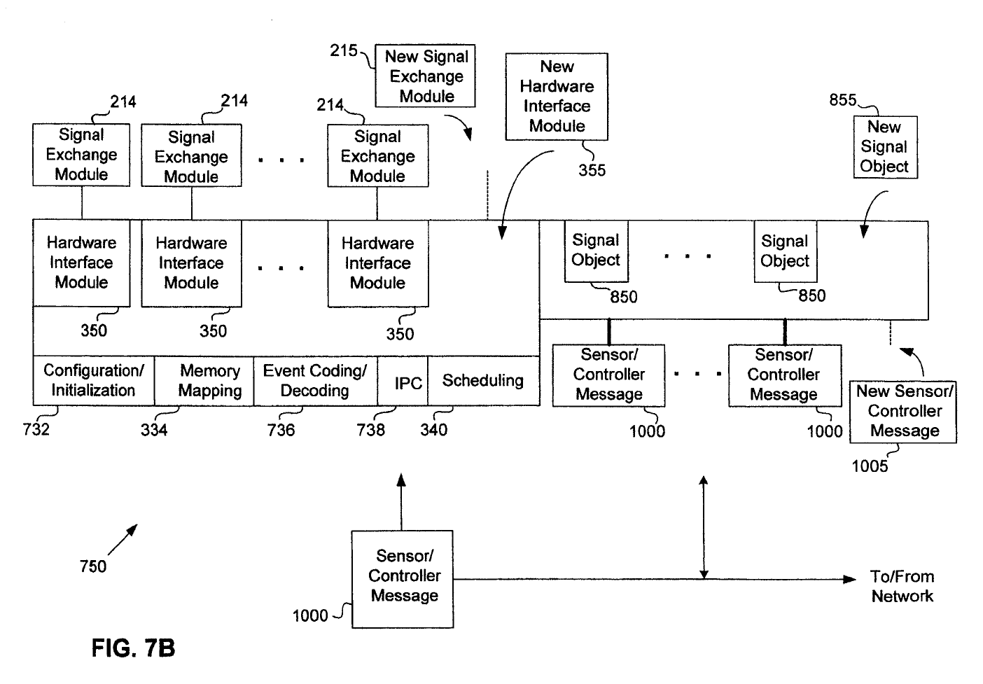

FIG. 8 is a set of signal database objects or tables 402, 404, 406, 808 that specifies exemplary configuration information for a signal exchange module 214 implemented as an IP module. In general, the signal database 405 comprises objects or structures that define one or more hardware/software boundaries. Such objects or structures may include parameters or attributes describing or elaborating upon characteristics of each signal exchange module 214. Such parameters may specify how the signal exchange module 214 may be accessed to exchange particular data signals corresponding thereto; one or more mappings between such data signals and event identifiers; and one or more associations between a signal exchange module 214 and a set of signal objects 850. Such parameters may also include a set of network subscription definitions that define manners of communicating information associated with or corresponding to the signal exchange module 214 across a network 110, as further described below.

Particular parameter values within any given signal database object or table 402, 404, 406, 808 may be determined automatically, for example, by retrieval of information specified in one or more hardware description files. Those skilled in the art will understand that the signal database 405 may reside in a variety of local or remote locations, in a manner analogous to that described above.

The configuration and initialization module 732 may issue one or more requests to the object manager 710 to retrieve an appropriate set of signal objects 850 and/or references thereto from the OBDMS 800. For each signal object 850 defined to be active within the sensing/controller framework module 730, the configuration and initialization module 732 may retrieve a set of corresponding sensor/controller message identifiers from the message database 480, and pass such sensor controller message identifiers to the signal object 850 to establish a set of sensor/controller message identifiers to which the signal object 850 may respond during system operation. In an alternate embodiment, the signal object 850 may retrieve such sensor/controller message identifiers itself.

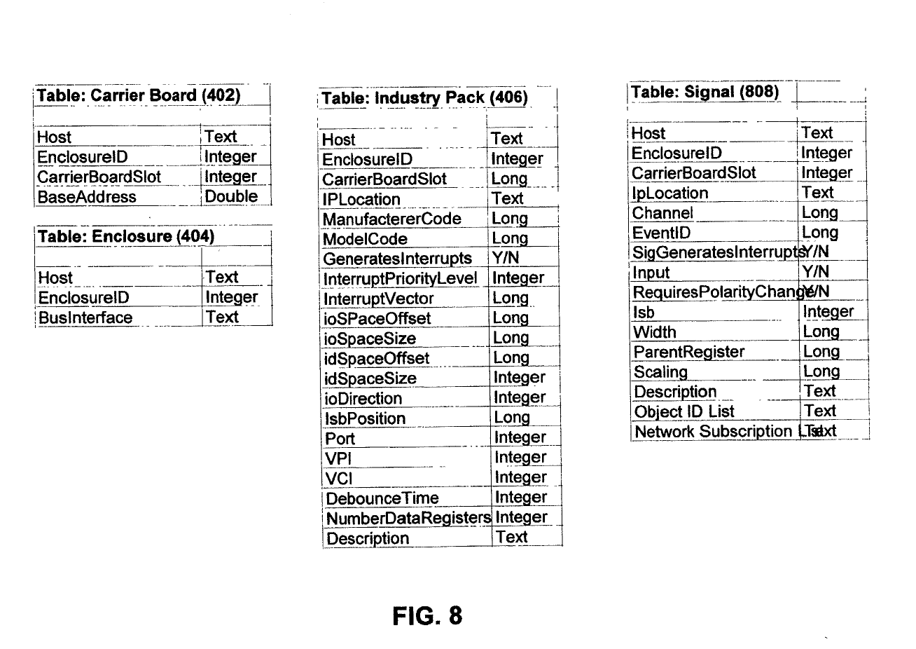

FIG. 9 is a message database object or table 482 organized in accordance with an embodiment of the invention. In one embodiment, a message database object or table 482 establishes relationships between a signal or service object identifier and a set of sensor/controller message identifiers to which the identified signal or service object is defined to be responsive. Those skilled in the art will recognize that the message database 482 may reside in a variety of local and/or remote locations, such as within the sensing/control framework and interface system 600; within the application services system 900; within the ODBMS 800; upon or within another type of system or device, such as a NAS device; or elsewhere.

In an embodiment in which signal objects 850 exist separately from hardware interface modules 350, the configuration and initialization module 732 may build or generate hardware interface modules 350 via an invocation of parameter-dependent executable files. The generation of hardware interface modules 350 may occur in a manner analogous to that described above.

The memory mapping module 334 may map a register and/or a memory address space associated with each signal exchange module 214 to addresses within the sensor/controller gateway's memory, such that signal exchange module storage locations appear as local addresses to the sensing/control framework module 730, 750. The event coding/decoding module 336 may map or encode data signals received from signal exchange modules 214 into corresponding sensor/controller messages 1000, and transform sensor/controller messages 1000 into data signals directed to appropriate signal exchange modules 214. The IPC module 338 may transmit sensor/controller messages 1000 to and receive sensor/controller messages 1000 from signal objects 850 and/or service objects 870. The scheduling module 340 may oversee or perform periodic or a periodic data collection operations within the sensor/controller framework module 730, 750 to facilitate communication with signal and/or service objects 850, 870.

As depicted in FIGS. 7A and 7B, a sensor/controller framework module 730, 750 may readily accommodate new or additional signal objects 855. New signal objects 855 may be created and stored in the ODBMS 800, and indicated for configuration or incorporation into the sensor/controller framework module 730, 750 through entries in the signal database 405 and the message database 480.

As previously indicated, service objects 870 within the application services system 900 may selectively respond to sensor/controller messages 1000. Referring again to FIG. 5, the application services system 900 may comprise a computer having one or more of the following as required: a processing unit, a set of input devices, a display device, a data storage unit, a network interface unit, and a memory, in a manner readily understood by those skilled in the art. Within the application services system's memory, an operating system may manage access to various hardware and/or software resources in a manner readily understood by those skilled in the art. Those skilled in the art will further understand that the operating system may be a real-time or non-real-time operating system, in accordance with temporal demands associated with any given sensing and/or control environment.

In one embodiment, the application services system 900 further comprises an object manager 910, an object cache 920, and an application services framework module 1130, each of which may reside within the application services system's memory. One or more portions of the object cache 920 and/or the application services framework module 1130 may reside upon a data storage device. The object manager 910 directs or oversees the exchange of service objects 870 between the ODBMS 800 and the object cache 920, as requested by the application services framework module 1130, and/or as necessary. Those skilled in the art will understand that one or more portions of the object manager 910 and the object cache 920 may be conventional.

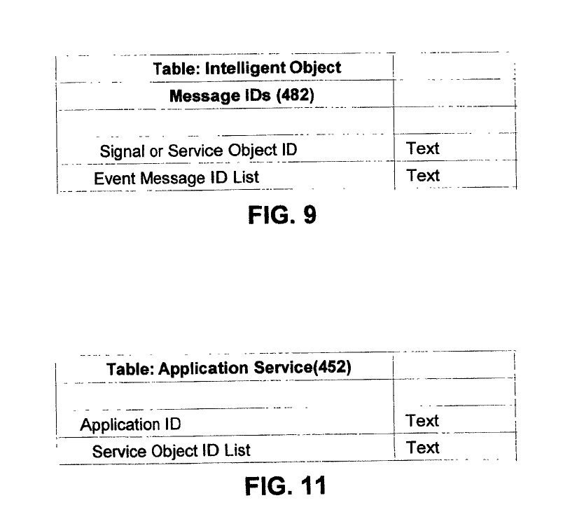

FIG. 10 is a functional block diagram of an application services framework module 1130 according to an embodiment of the invention. In one embodiment, the application services framework module 1130 comprises an object oriented software framework that includes a configuration and initialization module 1132, an inter-process communication (IPC) module 1138, and a set of service objects 870 that selectively process sensor/controller messages 1000. The application services framework module 1130 may comprise program instructions that reside within the application service system's memory and/or upon its data storage unit.

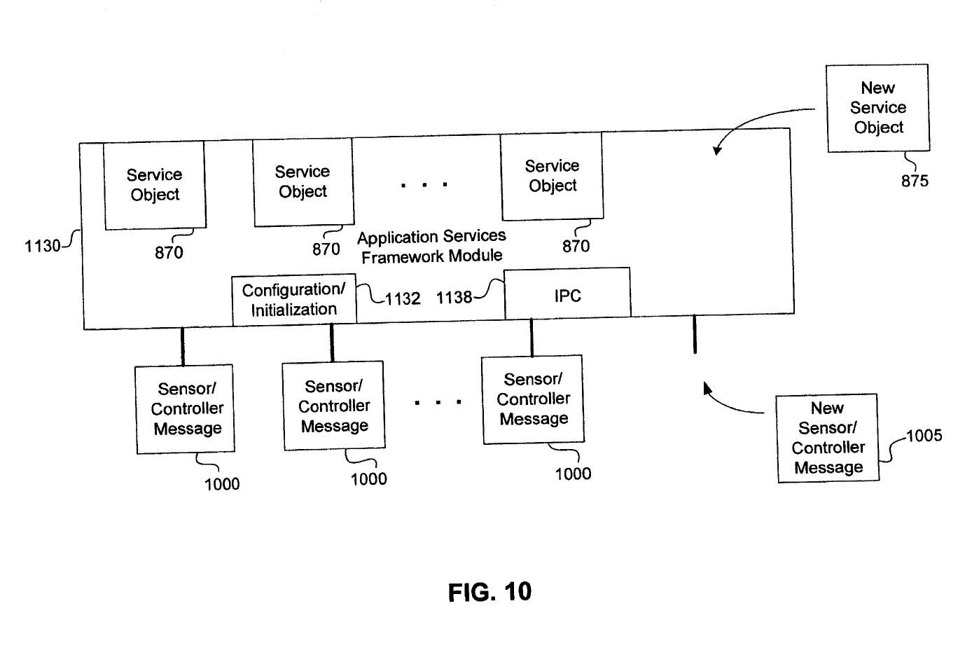

The configuration and initialization module 1132 may operate during an initialization mode to retrieve configuration information from the application database 450. FIG. 11 is an exemplary application database object or table 452 that specifies configuration information corresponding to a set of application services. In one embodiment, an application database object or table 452

specifies an application identifier; a set of service object identifiers associated therewith; and possibly a set of network subscription definitions for establishing communication with one or more sensor/controller framework modules 730, 750 and/or entities external to the architecture 105. Those skilled in the art will understand that the application database 450 may reside in a variety of local and/or remote locations, in a manner analogous to that described above in relation to the message database 480.

Upon retrieval of configuration information from the application database 450, the configuration and initialization module 1132 may issue one or more requests to the object manager 910 to retrieve service objects 870 and/or references thereto from the OBDMS 800. The service objects 870 and/or references may subsequently reside within the object cache 920.

For each service object 870 defined to be active within the application services framework module 1130, the configuration and initialization module 1132 may retrieve a set of corresponding sensor/controller message identifiers from the message database 480, and pass such sensor controller message identifiers to the service object 870 to establish a set of sensor/controller message identifiers to which the service object 870 may respond during system operation. In an alternate embodiment, the service object 870 may retrieve such sensor/controller message identifiers itself.

The configuration and initialization module 1132 may further establish and/or verify network connections to one or more sensing/control framework modules 730, 750 and/or hardware or software entities external to the architecture 105. The IPC module 1138 may control the exchange of sensor/controller messages 1000 between service objects 850 and various network connections. Service objects 870 may process information contained within or associated with sensor/controller messages 1000, and may further communicate with entities external to the architecture 105 as part of processing such information.

An application services framework module 1130 may readily accommodate new or additional service objects 875, as indicated in FIG. 10. New service objects 875 may be created and stored in the ODBMS 800, and indicated for configuration or incorporation into the application services framework module 1130 through appropriate entries in the application database 450 and the message database 480.

The architecture 105 described above may be applied to essentially any type of sensing and/or control environment, and may be readily scaled. Different portions of the architecture 105 may reside in different locations, which may be separated by significant distances. Through the use of signal and/or service objects 850, 870 and the signal, application, and/or message databases 405, 450, 480, the architecture 105 may facilitate a high degree of code reusability and system extensibility. The architecture 105 of the present invention may greatly simplify sensing/control system design, thereby minimizing the time required to develop, deploy, debug, and/or modify a sensing and/or control system directed to essentially any type of sensing and/or control environment.

### EXAMPLES

Through accessing information in the signal database 405 and/or the application database 450, the present invention may readily configure itself for processing sensor/controller messages 1000 associated with very wide variety of sensing and/or control environments. Various exemplary architecture configurations are described in detail hereafter to further aid understanding.

In a first example, a sensing subsystem A1 may include ten sensors, and another sensing subsystem A2 may include twenty sensors, where the types of sensors in subsystems A1 and A2 are identical. Sensing subsystems A1 and A2 may be served by an identical application database 450, while a signal database 405 serving sensing subsystems A1 and A2 may reflect the different number of sensors in each subsystem. In other words, the signal database 405 may describe the ten signal exchange modules 214 in subsystem A1 as well as the twenty signal exchange modules 214 in subsystem A2. The application database 450 need only describe a common set of service objects 870 (which may be a single service object 870) required for processing sensing messages 1000 associated with the particular type of sensor used in the two subsystems.

A single intelligent object may serve multiple or a predetermined number of sensors of a given type. For example, a sensing subsystem B1 may include twenty sensors at a first location, organized in pairs. That is, subsystem B1 includes ten sensor pairs. A sensing subsystem B2 may include fifteen sensor pairs at a second location, where the types of sensor pairs in subsystem B2 are identical to those in subsystem B1.

An application services framework module 1130 may reside upon or within a server at a third location. The application services framework module 1130 may establish and/or verify appropriate types of network connections to sensing subsystems B1 and B2, for example, Local Area Network (LAN) and/or Wide Area Network (WAN) connections. The application services framework module 1130 may include service objects 870 directed toward processing sensing messages 1000 received from sensor pairs. Thus, the application services system 900 may include a total of twenty-five service objects 870 and/or references thereto, such that ten service objects 870 are assigned to process sensing messages 1000 associated with the ten sensor pairs in subsystem B1, and fifteen service objects 870 are assigned to process sensing messages 1000 associated with the fifteen sensor pairs in subsystem B2.

In one embodiment, one or more service objects 870 within an application services framework module 1130 may generate an updated Extensible Markup Language (XML) page and/or one or more other document types. For example, a sensing subsystem C1 at a first location may include ten sensor sets, where each sensor set comprises eight different types of sensors. Another sensing subsystem C2 at a second location may include fifteen sensor sets, where each sensor set within subsystem C2 is identical to the sensor sets in subsystem C1.

An application services framework module 1130 may reside upon or within a server at a third location. In the application services framework module 1130, a service object 870 associated with a particular sensor set may generate an updated XML page and/or other type of document in response to each receipt of a sensing message 1000 associated with the particular sensor set. Thus, the application services system 1130 may include a total of twenty-five service objects 870, where ten service objects 870 are associated with sensing subsystem C1, and fifteen service objects 870 are associated with sensing subsystem C2. In such an embodiment, each service object 870 is remotely tied to one sensor set and one XML page. In alternate embodiments, one or more service objects 870 may selectively generate updated XML pages and/or other types of documents in accordance with processing operations performed upon the contents of sensing messages 1000.

A service object 870 may traverse the network subscription information for its associated sensors as defined within the signal database 405. Using the network subscription information, the service object 870 may transmit an XML page and/or other information across the network 110. Such transmission may occur in accordance with a variety of formats, such as an electronic mail message to which an XML page is attached, a pager notification, and/or a voice message notification. A service object 870 may alternatively transmit an XML page to a repository external to the architecture 105, and transmit a message or notification (such as an e-mail) that includes a reference for accessing or retrieving the XML page, in a manner readily understood by those skilled in the art.

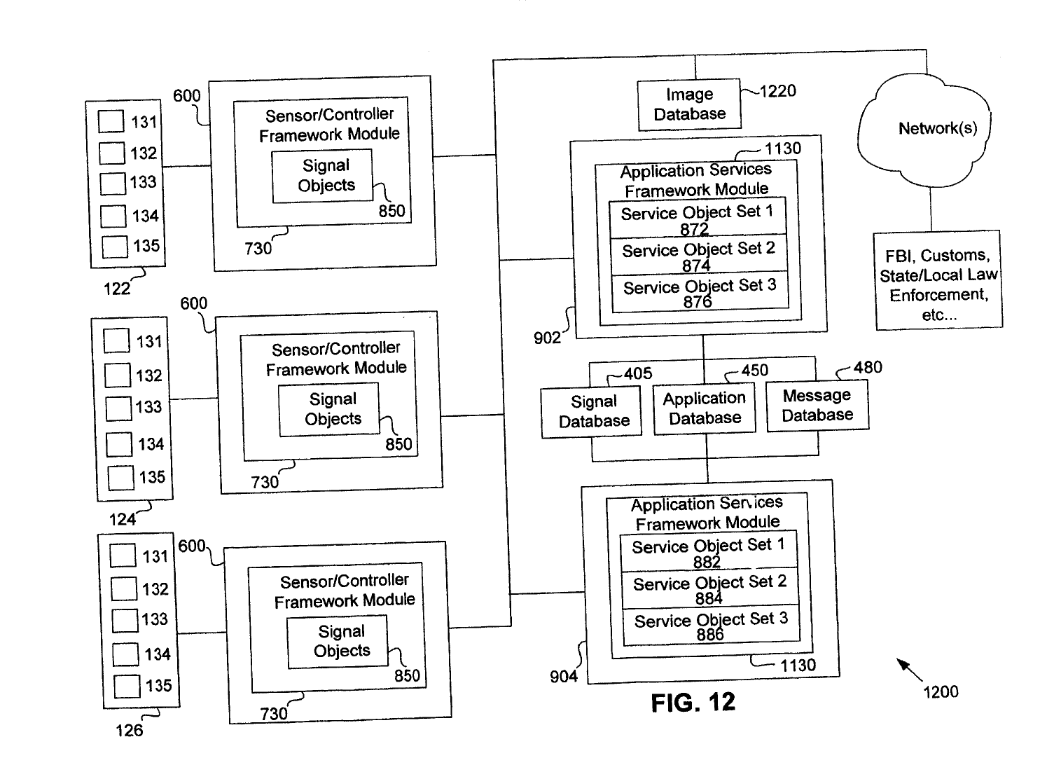

FIG. 12 is a block diagram showing an exemplary airport security environment 1200 in which an embodiment of the architecture 105 may operate. In the airport security environment 1200, a first camera subsystem 122, a second camera subsystem 124, and a third camera subsystem 126 respectively reside at a first, a second, and a third security checkpoint. Each camera subsystem 122, 124, 126 may include a first camera 131 for capturing a frontal view of a passenger; a second camera 132 for capturing a left profile view of the passenger; a third camera 133 for capturing a right profile view of the passenger; a fourth camera 134 for capturing a left angle view of the passenger; and a fifth camera 135 for capturing a right angle view of the passenger, in a manner understood by those skilled in the art.

Each camera subsystem 122, 124, 126 may be coupled to a corresponding sensing/control framework and interface system 600. In one embodiment, signal objects 850 within each sensing/control framework and interface system 600 may preprocess and/or compress video frames captured by the cameras 131, 132, 133, 134, 135 associated therewith, and subsequently issue video images and/or other information as sensor messages 1000 upon a LAN 112. Preprocessing could comprise, for example, determining whether a current video frame differs from a previous video frame; and/or execution of one or more signal processing algorithms to reduce an image to a set of key parameters, which may be used to perform a concise query upon an image database 1200 or other database, as further described below.

Service objects 870 executing within an application services system 900 coupled to the LAN 112 may receive such sensor messages 1000 and process the video images contained therein. The application services system 900 may be implemented using a dual-redundant computing system comprising a first server 902 and a second server 904. In the first server 902, a first set of service objects 872 may process video images corresponding to the first through fifth cameras 131, 132, 133, 134, 135 in the first camera subsystem 122; a second set of service objects 874 may process video images corresponding to the first through fifth cameras 131, 132, 133, 134, 135 in the second camera subsystem 124; and a third set of service objects 876 may process video images corresponding to the first through fifth cameras 131, 132, 133, 134, 135 in the third camera subsystem 126. Similarly, in a second server 904, a first set of service objects 882 may process video images corresponding to the first through fifth cameras 131, 132, 133, 134, 135 in the first camera subsystem 122; a second set of service objects 884 may process video images corresponding to the first through fifth cameras 131, 132, 133, 134, 135 in the second camera subsystem 124; and a third set of service objects 886 may process video images corresponding to the first through fifth cameras 131, 132, 133, 134, 135 in the third camera subsystem 126.

The exemplary airport security environment 1200 may include a signal database 405, an application database 450, and a message database 480 that sensing/control framework modules 730, 750 and an application services framework module 1130 may access for configuring the architecture 105. In the embodiment shown, the signal, application, and message databases 405, 450, 480 exist within the context of the application services system 900. Those skilled in the art will understand that the signal, the application, and/or the message database 405, 450, 480 could reside elsewhere in an alternate embodiment.

The airport security environment 1200 may further include one or more image databases 1220, in which individual and/or composite images associated with currently known criminal suspects may reside. In one embodiment, one or more service objects 870 and/or other objects may be dedicated to or directed toward maintaining the contents of an image database 1220 or other database. For example, a law enforcement computing system may attempt to distribute image updates from a central repository across secure network connections, for example, through a broadcast over a Virtual Private Network (VPN) using a Secure Sockets Layer (SSL) encryption protocol. A service object 870 may receive a VPN transmission and decrypt it, and post updated image data in the image database 1220. Original authentication certificates may be posted with the updated image data. Furthermore, a service object 870 may examine authentication certificates (possibly through a federated certificate server coupled to the network 110), and issue alerts to indicate database corruption exists in the event that a certificate authentication fails.

The service objects sets 872, 874, 876, 882, 884, 886 within the application services framework modules 1130 may perform image recognition operations to determine whether video images captured by their associated camera subsystems 122, 124, 126 match images within the image database 1220. If so, one or more service objects 870 may generate a recognition notification, which may comprise an XML page and/or one or more other documents, and issue the recognition notification over the network. The recognition notification may be directed, for example, to a network address associated with the Federal Bureau of Investigation (FBI).

Those skilled in the art will recognize that the architecture 105 described above may exhibit many variations. For example, a sensing/control framework and interface system 600 and an application services system 900 may be implemented using a single computer system. As another example, a sensing/control framework module 700 could selectively instantiate one or more service objects 870 in addition to or instead of particular signal objects 850. As another example, the application services system 900 may be directly coupled to one or more sensing/ control framework and interface systems 600. As yet another example, the architecture 105 may rely upon a managing server system 500 as described earlier rather than an application service system 900. As still another example, one or more service objects 850 may execute upon a computer system that is separate from that in which the sensor/controller framework module 730 executes. The present invention provides for these and other variations, and is limited only by the following claims.

What is claimed is:

1. A system comprising:
a hardware subsystem that includes at least one component adapted to carry an electrical signal associated with one from the group of a sensing operation and a control operation;
an application database storing application service configuration information that corresponds to a manner of processing information associated with the electrical signal; and
a self-configuring application services system comprising a configuration module coupled to the hardware subsystem and coupled to retrieve application service configuration information from the application database.

2. The system of claim 1, wherein:
the application service configuration information references a software object for processing information associated with the electrical signal, and
the application services system further comprises the software object.

3. The system of claim 2, further comprising an object database storing a version of the software object.

4. The system of claim 3, wherein the object database forms a portion of an Object Database Management System.

5. The system of claim 1, further comprising:
a signal database storing interface configuration information corresponding to a manner of managing communication between the hardware subsystem and the application services system; and
a self-configuring interface system coupled to the hardware subsystem and the application services system and comprising a configuration module coupled to retrieve interface configuration information from the signal database.

6. The system of claim 5, wherein said interface configuration information further references a software object that corresponds to a manner of processing information associated with the electrical signal.

7. The system of claim 6, wherein the interface system further comprises the software object.

8. The system of claim 7, further comprising an object database storing a version of the software object.

9. The system of claim 8, wherein the object database forms a portion of an Object Database Management System.

10. The system of claim 5, wherein the interface system communicates with the hardware subsystem in accordance with the electrical signal, and communicates with the application services system in accordance with an event code that corresponds to the electrical signal.

11. The system of claim 7, wherein the interface system communicates with the hardware subsystem in accordance with the electrical signal, and communicates with the software object and the application services system in accordance with an event code that corresponds to the electrical signal.

12. A system comprising:
a hardware subsystem that includes a set of components adapted to carry electrical signals, each electrical signal associated with one from the group of a sensing operation and a control operation;
an application database referencing a first software object that corresponds to a manner of processing information associated with an electrical signal;
a self-configuring application services system comprising:
a configuration module coupled to the hardware subsystem and coupled to retrieve application service configuration information from the application database; and
the first software object;
a signal database storing interface configuration information corresponding to a manner of managing communication between the hardware subsystem and the application services system and referencing a second software object that corresponds to a manner of processing information associated with an electrical signal; and
a self-configuring interface system coupled to the hardware subsystem and the application services system and comprising:
a configuration module coupled to retrieve interface configuration information from the signal database; and
the second software object.

13. The system of claim 12, further comprising an object database storing one from the group of the first software object and the second software object.

14. The system of claim 13, wherein the object database forms a portion of an Object Database Management System.

15. The system of claim 12, further comprising a network coupled to the application services system and tho system.

16. The system of claim 15, wherein the network comprises one from the group of a Local Area Network, a Wide Area Network, and the Internet.

17. The system of claim 12, wherein the interface system communicates with the hardware subsystem in accordance with the electrical signal, and communicates with the application services system in accordance with an event code that corresponds to the electrical signal.

18. The system of claim 12, wherein the interface system communicates with the hardware subsystem in accordance with the electrical signal, and communicates with the second software object and the application services system in accordance with an event code that corresponds to the electrical signal.

19. The system of claim 12, wherein the interface system further comprises a signal exchange module coupled to the hardware subsystem, the signal exchange module comprising a storage element for storing a hardware signal corresponding to an electrical signal.

20. The system of claim 12, wherein the interface system further comprises:
a signal exchange module coupled to the hardware subsystem, the signal exchange module comprising a storage element for storing a hardware signal corresponding to an electrical signal; and
an event coding-decoding module coupled to map between an electrical signal and an event code.

21. The system of claim 12, wherein the interface system further comprises:
a signal exchange module coupled to the hardware subsystem, the signal exchange module comprising a storage element for storing a hardware signal corresponding to an electrical signal;
an event coding-decoding module coupled to map between an electrical signal and an event code; and
an interprocess communication module coupled to manage event-based communication with the application services system.

22. The system of claim 12, wherein the interface system further comprises:
a signal exchange module coupled to the hardware subsystem, the signal exchange module comprising a storage element for storing a hardware signal corresponding to an electrical signal;
an event coding-decoding module coupled to map between an electrical signal and an event code; and
an interprocess communication module coupled to manage event-based communication with the application services system and the second software object.

23. In a system comprising a hardware subsystem that includes a set of components adapted to carry electrical signals, each electrical signal associated with one from the group of a sensing operation and a control operation, a method for processing an electrical signal comprising the steps of:
retrieving application service configuration information that references a software object that includes program instructions directed toward processing the electrical signal;
retrieving a software object in accordance with the application service configuration information;
retrieving interface configuration information corresponding to the hardware subsystem; and
automatically generating a hardware interface for managing communication between the software object and the hardware subsystem in accordance with the interface configuration information.

24. The method of claim 23, wherein the software object is retrieved from an object database.

25. The method of claim 23, wherein the software object is retrieved from an Object Database Management System.

26. The method of claim 23, further comprising the step of establishing a mapping between the electrical signal and an event code.

27. The method of claim 26, further comprising the steps of:
managing communication between the hardware subsystem and the interface system in accordance with the electrical signal; and
managing communication between the interface system and the software object in accordance with the event code.

28. The method of claim 23, wherein the hardware interface is associated with a first computer system, and the software object is associated with a second computer system.

29. In a system comprising a hardware subsystem that includes a set of components adapted to carry electrical signals, each electrical signal associated with one from the group of a sensing operation and a control operation, a method for processing electrical signals comprising the steps of:
retrieving application service configuration information that associates a first set of software objects with at least one electrical signal;
retrieving the first set of software objects in accordance with the application service configuration information;
retrieving interface configuration information that corresponds to the hardware subsystem and which associates a second set of software objects with at least one electrical signal; and
automatically generating a hardware interface for managing communication between the software object and the hardware subsystem in accordance with the interface configuration information.

30. The method of claim 29, wherein the first and second sets of software objects are retrieved from an object database.

31. The method of claim 29, wherein the first and second sets of software objects are retrieved from an Object Database Management System.

32. The method of claim 29, further comprising the step of establishing mappings between a set of electrical signals and a set of event codes for those electrical signals associated with software objects within the first set of software objects.

33. The method of claim 32, further comprising the steps of:
managing communication between the hardware subsystem and the interface system in accordance with the set of electrical signals; and
managing communication between the interface system and the first set of software objects in accordance with the set of event codes.

34. The method of claim 29, further comprising the step of establishing mappings between a set of electrical signals and a set of event codes for those electrical signals associated with software objects within the first and second sets of software objects.

35. The method of claim 34, further comprising the steps of:
managing communication between the hardware subsystem and the interface system in accordance with the set of electrical signals; and
managing communication between the interface system, the first set of software objects, and the second set of software objects in accordance with the set of event codes.

36. The method of claim 29, further comprising the steps of:
executing program instructions associated with the first set of software objects within a first computer system; and
executing program instructions associated with the second set of software objects within a second computer system.

37. The method of claim 36, wherein the second computer system includes the hardware interface.
